(19) United States
(12) Patent Application Publication
(10) Pub. No.: US 2026/0152127 A1
(43) Pub. Date: Jun. 4, 2026

(54) BRACKET ASSEMBLY AND STEP ASSEMBLY

(71) Applicant: RANGER DESIGN INC., Baie d'Urfé (CA)

(72) Inventors: Xin ZHANG, Baie d'Urfé (CA); Abbas GHAFFARI, Baie d'Urfé (CA); Murtaza ADAMJEE, Baie d'Urfé (CA)

(21) Appl. No.: 19/297,446

(22) Filed: Aug. 12, 2025

Related U.S. Application Data
(60) Provisional application No. 63/726,751, filed on Dec. 2, 2024.

(51) Int. Cl. B60R 3/02

(52) U.S. Cl. CPC B60R 3/02

(57) ABSTRACT

A bracket assembly, for connecting a step to an electric vehicle, includes an upper bracket having an upper connecting portion, a lower bracket having a lower connecting portion defining a lower guiding surface, and at least one connector connecting the upper and lower connecting portions to each other. When in use and connecting the step to the electric vehicle, the upper bracket is connected to the electric vehicle, the step is connected to the lower bracket, and is disposed vertically lower than the upper bracket. In response to an at least partially horizontal load being applied to at least one of the lower bracket and the step, and exceeding a predetermined value, the lower bracket separates from the upper bracket, and the upper guiding surface engages the lower guiding surface to guide movement of the lower bracket at least partially vertically downward relative to the upper bracket.

### CROSS-REFERENCE

The present application claims priority to U.S. Provisional Patent Application No. 63/726,751, entitled “Bracket Assembly and Step Assembly,” filed Dec. 2, 2024, the entirety of which is incorporated by reference herein.

### TECHNICAL FIELD

The present technology relates to bracket assemblies for connecting steps to electric vehicles.

### BACKGROUND

Cargo vans and similar vehicles are commonly used commercially to transport equipment, tools, and supplies. In order to assist in its required operations, a number of accessories have been developed specifically for commercial or fleet vans. These accessories include steps to be connected to lateral sides of a van to aid a user to more easily enter or access a side door or opening in the van.

With the increasing adoption of electric vehicles and the corresponding infrastructure, commercial and fleet vehicles have also begun being adapted for electrification. In a fully electric van, there is often a skateboard battery chassis where lower portions of the frame or chassis are formed by the battery itself. As some conventional accessories previously connected to bottom sections of the frame, some accessories must be redesigned in order to be compatible with electric vehicles.

Therefore, there is a desire for a solution addressing at least some of these drawbacks.

### SUMMARY

It is an object of the present technology to ameliorate at least some of the inconveniences present in the prior art.

In accordance with some aspects of the present technology, there is presented a bracket assembly for connecting a step to an electric vehicle. Using conventional step assemblies with electric vehicles could potentially result in damage to the vehicle, such as for example to the battery, in the case of a side impact. By the present technology, the bracket assembly is arranged and configured to break and separate the step from the vehicle under a horizontal impact. The assembly is formed from two portions which are selectively separable, with the fastener(s) holding the portions together being arranged to break under horizontal force. This permits the lower portion, to which a step is attached, to break away from the upper portion of the bracket, which is connected to the vehicle. The connection of the upper portion and the lower portion includes an angled surface, such that the lower portion of the bracket and the step connected thereto is pushed partially downward under a horizontal force. The downward motion aids in preventing contact between the step and bottom components of the vehicle, which may include the vehicle battery in an electric vehicle.

According to one aspect of the present technology, there is provided a bracket assembly for connecting a step to an electric vehicle. The bracket assembly includes an upper bracket, a lower bracket and at least one connector. The upper bracket is configured to connect to the electric vehicle. The upper bracket has an upper connecting portion defining an upper guiding surface. The lower bracket has a lower connecting portion defining a lower guiding surface configured to engage with the upper guiding surface. The at least one connector connects the upper connecting portion of the upper bracket and the lower connecting portion of the lower bracket to each other. When in use and connecting the step to the electric vehicle, the upper bracket is connected to the electric vehicle, the step is connected to the lower bracket with the step being disposed vertically lower than the upper bracket. In response to an at least partially horizontal load being applied to at least one of the lower bracket and the step, and the at least partially horizontal load exceeding a predetermined value, the lower bracket separates from the upper bracket, and the upper guiding surface engages the lower guiding surface to guide movement of the lower bracket at least partially vertically downward relative to the upper bracket.

In some embodiments, the upper guiding surface is angled so as to define an acute angle with respect to a horizontal plane, the acute angle extending above the horizontal plane.

In some embodiments, in response to the at least partially horizontal load exceeding the predetermined value, the at least one connector breaks.

In some embodiments, the at least one connector selectively connects the upper and lower brackets to each other.

In some embodiments, the at least one connector includes at least one bolt and at least one corresponding nut.

In some embodiments, the at least one bolt is a 8-32 bolt, a 8-36 bolt, a 10-24 bolt, a 10-32 bolt, a 12-24 bolt, a 12-28 bolt, a ¼″-20 bolt or ¼″-28 bolt.

In some embodiments, the at least one connector extends through the upper guiding surface and the lower guiding surface.

In some embodiments, the lower bracket has an engaging portion configured to engage with the electric vehicle.

In some embodiments, at least one of the upper bracket and the lower bracket is made of cold rolled carbon steel.

In some embodiments, the electric vehicle is an electric van, and the bracket assembly is configured to connect the step to a lateral right or left side of the electric van.

In some embodiments, the bracket assembly further includes the step.

According to another aspect of the present technology, there is provided a step assembly for an electric vehicle, the step assembly including at least one bracket assembly according to the above aspect or according to the above aspect and one or more of the above embodiments, and at least one step connected to the at least one bracket assembly.

For purposes of this application, terms related to spatial orientation when referring to the step assembly or components thereof such as forwardly, rearwardly, top, bottom, left, and right are as they would normally be understood by a driver of the vehicle sitting thereon in a normal riding position with the step assembly installed thereon.

Embodiments of the present technology each have at least one of the above-mentioned aspects, but do not necessarily have all of them. Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, right side perspective view of a vehicle with a step assembly according to a non-limiting embodiment of the present technology;

FIG. 2 is a top, rear, right side perspective view of the step assembly of FIG. 1;

FIG. 3 is an exploded perspective view of the step assembly of FIG. 2;

FIG. 4 is a close-up of one bracket assembly of the step assembly of the exploded view of FIG. 3;

FIG. 5 is a rear elevation view of the step assembly of FIG. 2;

FIG. 6 is a schematic, partial rear view of the step assembly and the vehicle of FIG. 1, illustrated with a horizontal force applied to the step; and

FIG. 7 is a schematic, partial rear view of the step assembly and the vehicle of FIG. 1, illustrated during separation of the step from the vehicle.

It should be noted that the Figures may not be drawn to scale, unless otherwise noted.

### DETAILED DESCRIPTION

A step assembly 100 and bracket assemblies 102 according to an embodiment of the present technology will be described with reference to an electric vehicle 50. The electric vehicle 50 is an electric cargo van 50. It is contemplated that the step assembly 100 could be used with other types of electric vehicles 50, such as, for example, electric trucks.

The electric cargo van 50, henceforth simply referred to as van 50, has a frame 52 with front left and right doors 54 (only right front door 54 being shown in FIG. 1), a sliding side door 56, and rear doors 58. The front doors 54 provide access to a passenger compartment. The sliding side door 56, which is disposed on a right side of the van 50, provides access to a cargo compartment from a side of the van 50. The rear doors 58 also provide access to the cargo compartment, but from a rear of the van 50. It is contemplated that the van could additionally or alternatively have a left side sliding door, depending on the embodiment.

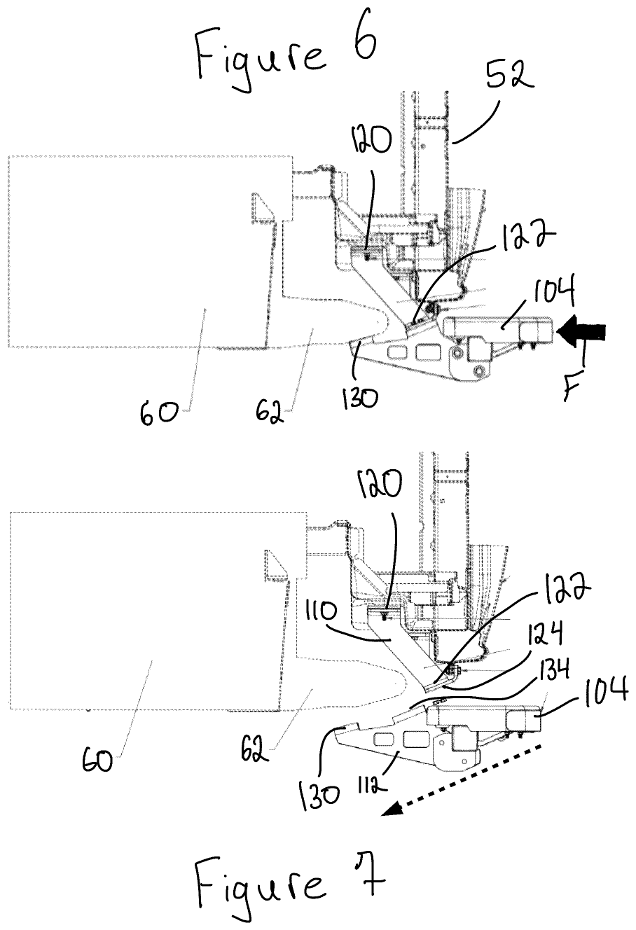

The van 50 has a battery 60 (schematically shown in FIGS. 6 and 7) forming a portion of the frame 52. The battery 60 is generally disposed vertically below a cabin forming portion of the frame 52. The battery 60 is at least partially surrounded by a battery protector 62. It is contemplated that in some embodiments, the battery 60 may be encased in the battery protector 62. In some embodiments, the battery protector 62 may be omitted.

The present technology provides a step assembly 100 for connecting to the van 50, shown installed in FIG. 1. The step assembly 100 is connected to the frame 52. In the illustrated embodiment, the step assembly 100 is positioned on the right lateral side of the frame 52, and is generally longitudinally aligned with the sliding side door 56 for facilitating access to the cargo compartment. The step assembly 100 is also longitudinally aligned with at least part of the battery 60.

It is contemplated that the van 50 may be equipped with additional step assemblies 100. For example, in some embodiments, there may step assemblies 100 that are longitudinally aligned with the front doors 54 for facilitating access to the passenger compartment. An additional step assembly 100 for facilitating access to a left side sliding door could additionally or alternatively be installed, depending on the arrangement of the van 50.

The step assembly 100 includes three bracket assemblies 102 and two steps 104. It is contemplated that the number of bracket assemblies 102 and/or the number of steps 104 could vary. For example, in some embodiments, the step assembly 100 could include two bracket assemblies 102 and one step 104 or a single bracket assembly 102 and one step 104.

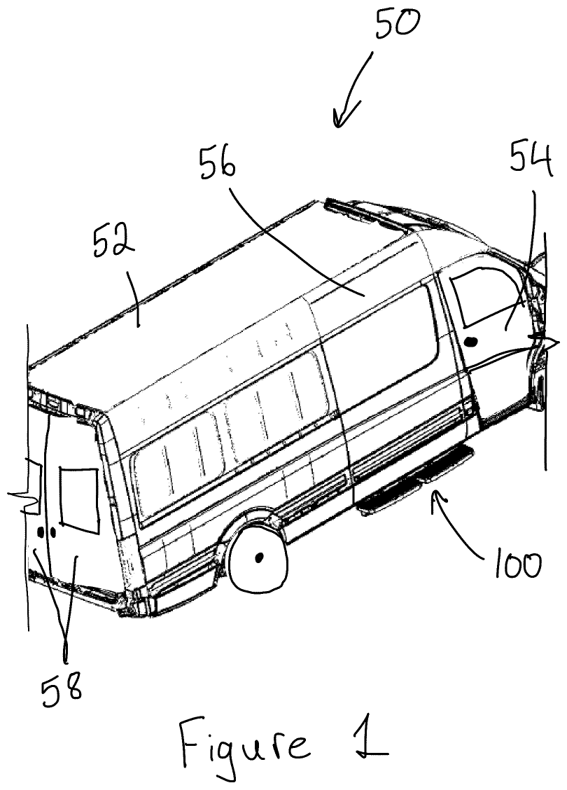

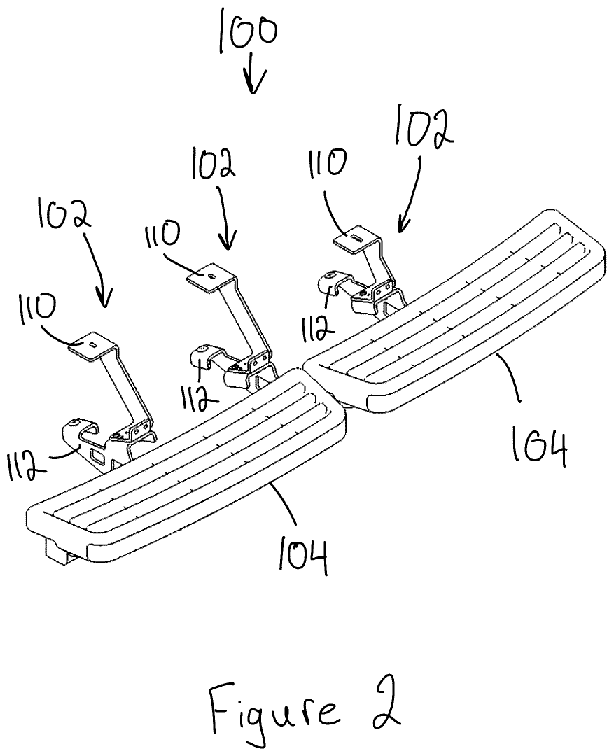

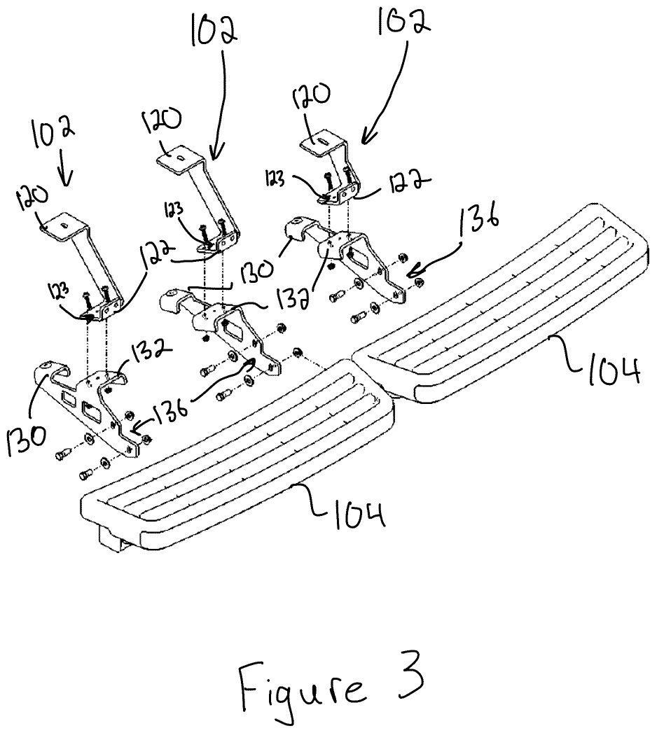

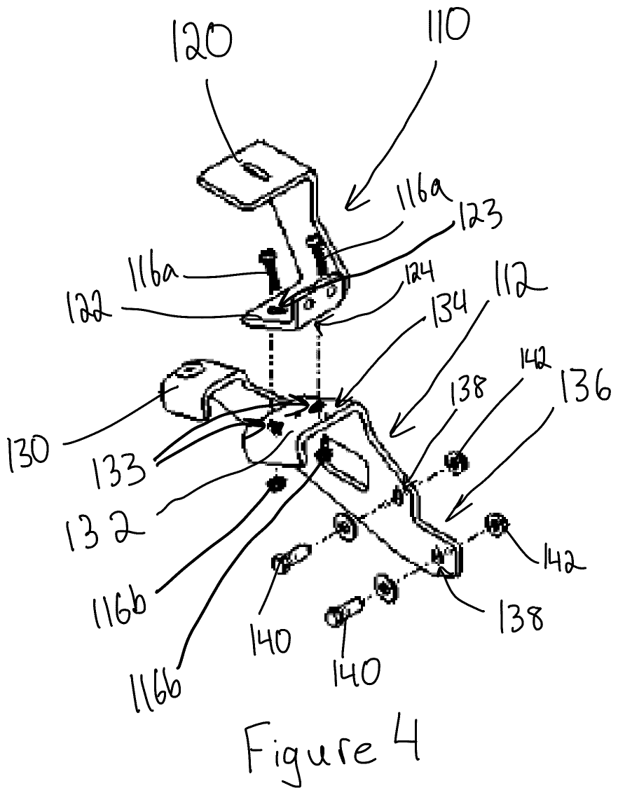

Referring to FIGS. 3 to 5, the bracket assemblies 102 will now be described in greater detail. As the three bracket assemblies 102 are the same, only one bracket assembly 102 will be described herein.

The bracket assembly 102 includes an upper bracket 110, a lower bracket 112, bolts 116a and nuts 116b, together referred to as connectors 116. The connectors 116 connect the upper bracket 110 and the lower bracket 112 to one another.

The bolts 116a and the nuts 116b, i.e. the connectors 116, provide a selective connection between the upper and lower brackets 110, 112. It is contemplated that in other embodiments, the connectors 116 could be other types of connectors 116 such as, for example, pins or rivets.

In the illustrated embodiment, the bracket assembly 102 includes two bolts 116a and two nuts 116b. It is contemplated that in other embodiments, there could be a single bolt 116a and a single nut 116b (i.e., there could only be one single connector 116). It is further contemplated that in other embodiments, there could be three or more bolts 116a and three or more nuts 116b (i.e., there could be three or more connectors 116). The bolts 116a are 10-32 bolts. It is understood that bolts of other sizes could be used. For example, the bolts 116a could be 8-32 bolts, 8-36 bolts, 10-24 bolts, 12-24 bolts, 12-28 bolts, ¼″-20 bolts or ¼″-28 bolts.

As will be described below, in certain situations, the lower bracket 112 can separate from the upper bracket 110 and is directed to move in an at least partially downward direction.

The upper bracket 110 has a vehicle connecting portion 120 by which the upper bracket 110 can be connected to an underside of the frame 52.

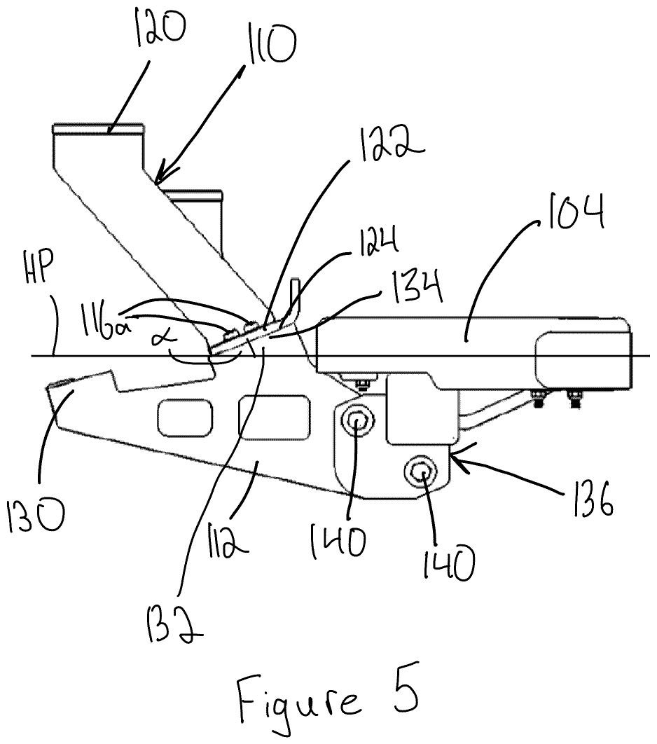

The upper bracket 110 further has an upper connecting portion 122 that is vertically lower than, laterally outward from and longitudinally aligned with the vehicle connecting portion 120. The upper connecting portion 122, by which the upper bracket 110 can connect to the lower bracket 112, defines two upper apertures 123 configured to receive part of the connectors 116. The upper connecting portion 122 also defines an upper guiding surface 124. The upper guiding surface 124, as best seen in FIG. 5, is angled relative to a horizontal plane HP. More specifically, an acute angle α, extending above the horizontal plane HP, is defined between the guiding surface 124 and the horizontal plane HP.

Still referring to FIGS. 3 to 5, the lower bracket 112 will now be described in greater detail. The lower bracket 112 includes, at laterally innermost end thereof, an engaging portion 130. As will be described below, the engaging portion 130 is configured to engage the battery protector 62 in some instances.

The lower bracket 112 further includes, laterally outward from the engaging portion 130, a lower connecting portion 132 that is configured to connect to the upper connecting portion 122. The lower connecting portion 132 defines two lower apertures 133 configured to receive the connectors 116.

Each of the two bolts 116a is received through a respective one of the two upper apertures 123, and through a respective one of the two lower apertures 133. The nuts 116b are then fastened to their respective bolts 116a, thereby connecting the upper and lower brackets 110, 112 to one another. The bolts 116a extend through the upper and lower guiding surfaces 124, 134, but it is contemplated that this may not be the case in other embodiments. For example, in another embodiment, the bolts 116a, 116b could be connected to one another via horizontal flanges that are separate from the upper and lower guiding surfaces 124, 134.

The lower bracket 112 defines a lower guiding surface 134. More specifically, the lower connecting portion 132 defines the lower guiding surface 134. It is contemplated that in other embodiments, the lower guiding surface 134 may be separate from the lower connecting portion 132. As will be described below, in some situations, the engagement between the upper guiding surface 124 and the lower guiding surface 134 can assist in guiding movement of the lower bracket 112 relative to the upper bracket 110.

The lower bracket 112 further includes, laterally outwardly from the lower connecting portion 132, a step connecting portion 136 that is configured to connect to the step 104. More specifically, the step connecting portion 136 defines two apertures 138, where each aperture 138 receives a bolt 140 therein. The bolt 140 also extends through an aperture (not shown) defined in the step 104. A nut 142 secures the step 104 to the lower bracket 112. It is contemplated that different fasteners could be used to connect the lower bracket 112 to the step 104.

In the present embodiment, the upper and lower brackets 110, 112 are made of cold rolled carbon steel. It is contemplated that in other embodiments, the upper and lower brackets 110, 112 could be made of another material.

The step 104 is connected to the lower bracket 112 via the bolts 140 and the nuts 142. It is contemplated that in other embodiments, the step 104 could be connected to the lower bracket 112 differently. In some embodiments, the step 104 may be integral with the lower bracket 112.

The step 104 is positioned to be mostly lower than the upper bracket 110. As best seen in FIG. 6, the step 104 is partially vertically aligned with the battery 60 when installed on the van 50. Additionally, the step 104 is positioned to extend laterally outwardly from the upper and lower brackets 110, 112. More specifically, the step 104 extends at least partially laterally beyond the sliding side door 56 so that someone can easily step thereon.

It will be appreciated that in some circumstances, when a high load is applied on the step 104 (e.g., when someone steps on the step 104 while carrying a heavy item), the engaging portion 130 engages the battery protector 62, allowing a portion of the load to be supported by the battery protector 62 and assisting in providing stability to the step assembly 100. It is contemplated that the engaging portion 130 could be omitted in some embodiments.

The bracket assembly 102 is configured such that when a horizontal or partially horizontal load that exceeds a predetermined threshold is applied to the step 104 or the lower bracket 112, the lower bracket 112 separates from the upper bracket 110. The lower bracket 112 subsequently moves at least partially vertically downward, away from the battery 60 and the battery protector 62.

One example situation is schematically illustrated in FIG. 6. Because the step 104 extends laterally beyond the frame 52, in response to a side impact (e.g., an object such as another vehicle colliding with the lateral side of the van 50), a force F may be applied to the step 104. The force F is depicted as being a horizontal force oriented toward the van 50. However, it is contemplated that in other embodiments, the force F may have a vertical component (i.e., may be partially oriented or angled vertically upward or vertically downward).

If a magnitude of the force F is less than a predetermined value, then the step assembly 100 remains generally intact. The predetermined value is at least partially dependent on the connectors 116. More specifically, the predetermined value can be estimated by using specific sized bolts (e.g., 10-32) for which the failing point in shear is known.

If the magnitude of the force F is greater than the predetermined value, then the step assembly 100 partially comes apart. More specifically, the bolts 116a, 116b break, thereby disconnecting the lower bracket 112 from the upper bracket 110. In the present embodiment, the bolts 116a, 116b break in shear. In some embodiments, the bolts 116a, 116b could be positioned such that when a horizontal load is applied to the step assembly 102, the bolts 116a, 116b only sustain shearing stresses.

Once the upper and lower brackets 110, 112 are disconnected from one another, since the force F is still being applied to the lower bracket 112 via the step 104, and the lower bracket 112 is still connected to the step 104, the lower bracket 112 and the step 104 begin moving relative to the upper bracket 110. The horizontal force or the horizontal component of the force F still being applied, the lower bracket 112 and the step 104 are moved laterally inward.

The upper guiding surface 124 and the lower guiding surface 144 engage with one another, which in turn guides movement of the lower bracket 112 and the step 104 relative to the upper bracket 110 (and thus relative to the van 50, since the upper bracket 110 is still fixedly connected to the frame 52).

The orientation of the upper and lower guiding surfaces 124, 134 is such that the lower bracket 112 and the step 104 are directed partially downward as they are forced inward. The lower bracket 112 and the step 104 are thus directed away from the battery 60 and the battery protector 62, which can assist in limiting likelihood of the step assembly 100 or components thereof, from impacting the battery 60 in the event of an accident or side impact.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A bracket assembly for connecting a step to an electric vehicle, the bracket assembly comprising:
an upper bracket configured to connect to the electric vehicle, the upper bracket having an upper connecting portion defining an upper guiding surface;
a lower bracket having a lower connecting portion defining a lower guiding surface configured to engage with the upper guiding surface; and
at least one connector connecting the upper connecting portion of the upper bracket and the lower connecting portion of the lower bracket to each other,
when in use and connecting the step to the electric vehicle:
the upper bracket is connected to the electric vehicle,
the step is connected to the lower bracket, the step being disposed vertically lower than the upper bracket, and
in response to an at least partially horizontal load being applied to at least one of the lower bracket and the step, and the at least partially horizontal load exceeding a predetermined value:
the lower bracket separates from the upper bracket, and
the upper guiding surface engages the lower guiding surface to guide movement of the lower bracket at least partially vertically downward relative to the upper bracket.

2. The bracket assembly of claim 1, wherein the upper guiding surface is angled so as to define an acute angle with respect to a horizontal plane, the acute angle extending above the horizontal plane.

3. The bracket assembly of claim 1, wherein in response to the at least partially horizontal load exceeding the predetermined value, the at least one connector breaks.

4. The bracket assembly of claim 1, wherein the at least one connector selectively connects the upper and lower brackets to each other.

5. The bracket assembly of claim 4, wherein the at least one connector includes at least one bolt and at least one corresponding nut.

6. The bracket assembly of claim 5, wherein the at least one bolt is a 8-32 bolt, a 8-36 bolt, a 10-24 bolt, a 10-32 bolt, a 12-24 bolt, a 12-28 bolt, a ¼″-20 bolt or ¼″-28 bolt.

7. The bracket assembly of claim 4, wherein the at least one connector extends through the upper guiding surface and the lower guiding surface.

8. The bracket assembly of claim 1, wherein the lower bracket has an engaging portion configured to engage with the electric vehicle.

9. The bracket assembly of claim 1, wherein at least one of the upper bracket and the lower bracket is made of cold rolled carbon steel.

10. The bracket assembly of claim 1, wherein:
the electric vehicle is an electric van; and
the bracket assembly is configured to connect the step to a lateral right or left side of the electric van.

11. The bracket assembly of claim 1, further comprising the step.

12. A step assembly for an electric vehicle, the step assembly comprising:
at least one bracket assembly of claim 1; and
at least one step connected to the at least one bracket assembly.
